(19) United States
(12) Patent Application Publication
(10) Pub. No.: US 2007/0086193 A1
(43) Pub. Date: Apr. 19, 2007

(54) Luminous display stand

(76) Inventor: Chun-Ming Chen, Yung Kung City (TW)

Correspondence Address: PRO-TECHTOR INTERNATIONAL SERVICES, 20775 NORADA CT., SARATOGA, CA, 95070, US

(21) Appl. No.: 11/357,698

(22) Filed: Feb. 18, 2006

(30) Foreign Application Priority Data
Oct. 13, 2005 (TW) 94217672

(51) Int. Cl. F21V 23/04

(52) U.S. Cl. 362/276

(57) ABSTRACT

A luminous display stand is disclosed to include a stand, a frame affixed to the top side of the stand, a transparent board mounted within the frame and back-covered with a layer of mercury coating, LEDs mounted in the frame for emitting light toward the transparent board, a battery pack mounted in the stand and controlled by an electric switch to provide the necessary working voltage to the LEDs, and a fluorescent material attached to the board to show a design that produces light upon radiation of the light from the LEDs.

### BACKGROUND OF THE INVENTION

1. Field of the Invention

The present invention relates to a display stand and more particularly, to a luminous display stand, which uses LEDs to provide illumination and, which has the advantages of high mobility, high durability and thin thickness.

2. Description of the Related Art

A store, shop, retail center or the like may use a display stand to provide instructions, messages, information and etc. to the consumers. Conventionally, a display stand is simply a stand having a board at the top for holding a message sheet or the like. When using a display stand to show instructions, messages, information or other matters at night, an external illumination is necessary. Recently, many luminous display stands have been disclosed. These luminous display stands are provided with a light source that gives off light. A light source for this purpose may be comprised of colored incandescent bulbs, fluorescent tubes, cold cathode fluorescent lamp (CCFL). These light emitting devices are fragile, require much installation space, and consume much power during operation.

Taiwan patent No. M265735, issued to the present inventor, discloses a light board assembly, which comprises a board, a fluorescent material attached to the surface of the board, and a light source provided at one lateral side or both the two opposite lateral sides of the board. The light source is comprised of a plurality of bulbs of different colors, a power socket, a switch, and a programmable control circuit board. The programmable control circuit board is electrically coupled to the bulbs and adapted to control on/off and flashing mode of the bulbs. Under the radiation of the light from the bulbs, the fluorescent material produces light. This design of light board assembly is heavy and bulky, and must be used with an easel or big stand. When a stand is used, a bracket or complicated mounting assembly shall be provided for securing the light board assembly to the stand. When the light board assembly is fastened to an easel or stand, the whole assembly is heavy and not convenient for movement.

### SUMMARY OF THE INVENTION

The present invention has been accomplished under the circumstances in view. It is therefore the main object of the present invention to provide a luminous display stand, which has a thin thickness and is convenient for carrying or moving. It is another object of the present invention to provide a luminous display stand, which is durable in use. It is still another object of the present invention to provide a luminous display stand, which causes a sense of animate and provides a satisfactory display effect. To achieve these and other objects of the present invention, the luminous display stand comprises a stand for positioning on the floor; a light board assembly supported on the stand, the light board assembly comprising a board mounted, at least one light emitting diode adapted to emit light toward the board, a battery pack mounted in the stand and adapted to provide the necessary working power to the at least one light emitting diode, and an electric switch electrically coupled between the battery pack and the at least one light emitting diode for controlling the supply of electricity from the battery pack to the at least one light emitting diode; and a fluorescent material attached to the board to show a design.

In one embodiment, the at least one light emitting diode of the light board assembly includes a plurality of light emitting diodes of same color connected in series. In another embodiment of the present invention, the at least one light emitting diode of the light board assembly includes a plurality of light emitting diodes of different colors.

The light board assembly further comprises a control circuit board electrically coupled between the at least one light emitting diode and the electric switch and adapted to control the operation mode of the at least one light emitting diode. The control circuit board can be mounted inside the stand. Alternatively, the control circuit board can be mounted outside the sand.

The light board assembly further comprises an electric connector mounted inside the stand and electrically coupled to the at least one light emitting diode through the electric switch for the connection of an external AC adapter, and a charging circuit board mounted inside the stand and electrically coupled to the battery pack for charging the battery pack with external power supply.

Further, the fluorescent material can be applied to the board by handwriting, or by printing. The board of the light board assembly has the back wall covered with a layer of mercury coating or a layer of mercury film. The light board assembly further comprises a frame fixedly fastened to the stand to hold the board. The board can be made having a design engraved thereon.

### BRIEF DESCRIPTION OF THE DRAWINGS

FIG. 1 is a perspective exploded view of a luminous display stand according to the present invention.

FIG. 2 is a perspective exploded view of an alternate form of the luminous display stand according to the present invention.

FIG. 3 is a perspective assembly view of the luminous display stand according to the present invention.

FIG. 4 is a perspective assembly view of another alternate form of the luminous display stand according to the present invention.

FIG. 4A is a perspective exploded view of still another alternate form of the luminous display stand according to the present invention.

FIG. 4B is a perspective exploded view of still another alternate form of the luminous display stand according to the present invention.

FIG. 5 is a perspective assembly view of still another alternate form of the luminous display stand according to the present invention.

FIG. 6 is a schematic side view of still another alternate form of the present invention, showing the tilting angle of the light board assembly adjusted.

FIG. 7 is a schematic front view of still another alternate form of the luminous display stand according to the present invention.

FIG. 8 shows a number of luminous display stands linked with chains according to the present invention.

### DETAILED DESCRIPTION OF THE PREFERRED EMBODIMENT

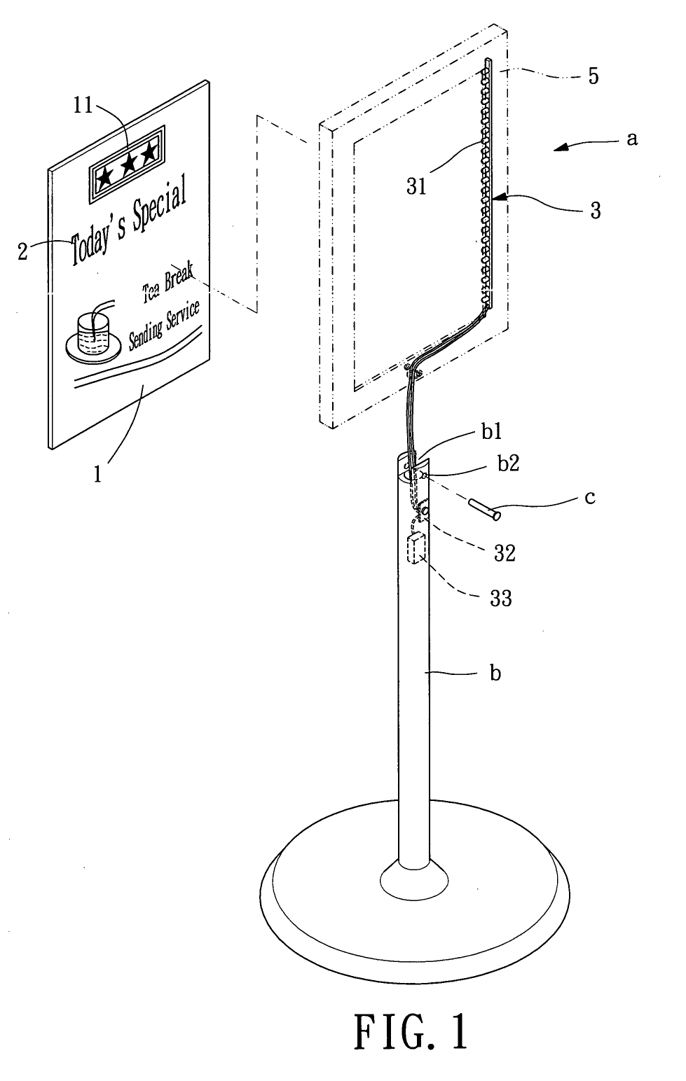

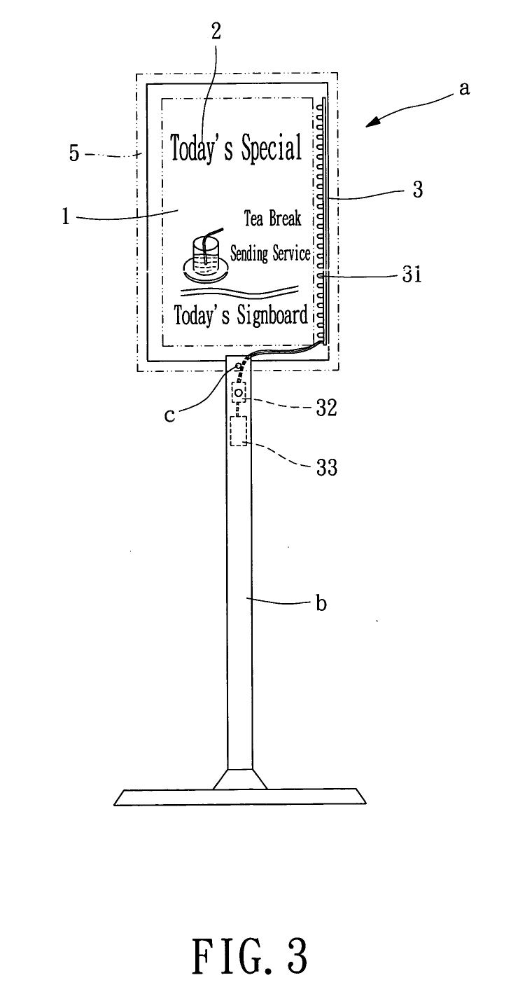

Referring to FIGS. 1 and 3, a luminous display stand in accordance with the present invention is shown comprised of a light board assembly a and a stand b.

The light board assembly a is supported on the top side of the stand b, comprising a frame 5, a display board 1, a fluorescent material 2, and a LED light source 3. The frame 5 is fixedly fastened to the top side of the stand b. The display board 1 may be a transparent board made of, for example, acrylic or glass fastened to one side, namely, the front side of the frame 5 in a flush manner, having an engraved design (logo, see FIG. 1) 11 made by a laser apparatus or CNC machine. The fluorescent material 2 is applied to the surface of the display board 1 by means of a fluorescent pen or directly printed on the display board 1 to show a product blurb and/or service content and/or precautionary statement. The LED light source 3 comprises a plurality of LEDs (light emitting diodes) 31 installed in the frame 5 around (or at the back side of) the display board 1, a battery pack 33 mounted in the stand b, and a switch 32 installed in the stand b and electrically connected between the battery pack 33 and the LEDs 31 for controlling the supply of battery power from the battery pack 33 to the LEDs 31. Further, the display board 1 has the back wall coated with a layer of mercury coating, or covered with a layer of mercury film.

The stand b can be made of plastics, metal, wood, or any of a variety of materials, having a top locating notch b1 and a transverse pinhole b2 extending across the top locating notch b1. The light board assembly a is inserted with the bottom side thereof into the top locating notch b1, and then a fastening member, for example, a pin c is fastened to the transverse pinhole b2 to affix the light board assembly a to the stand b.

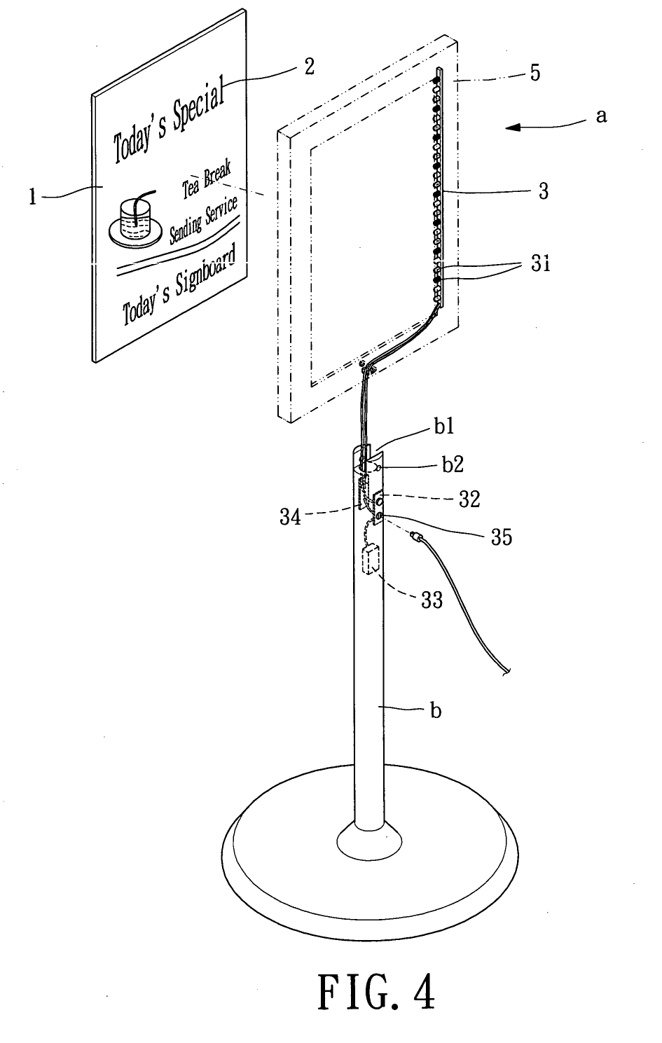

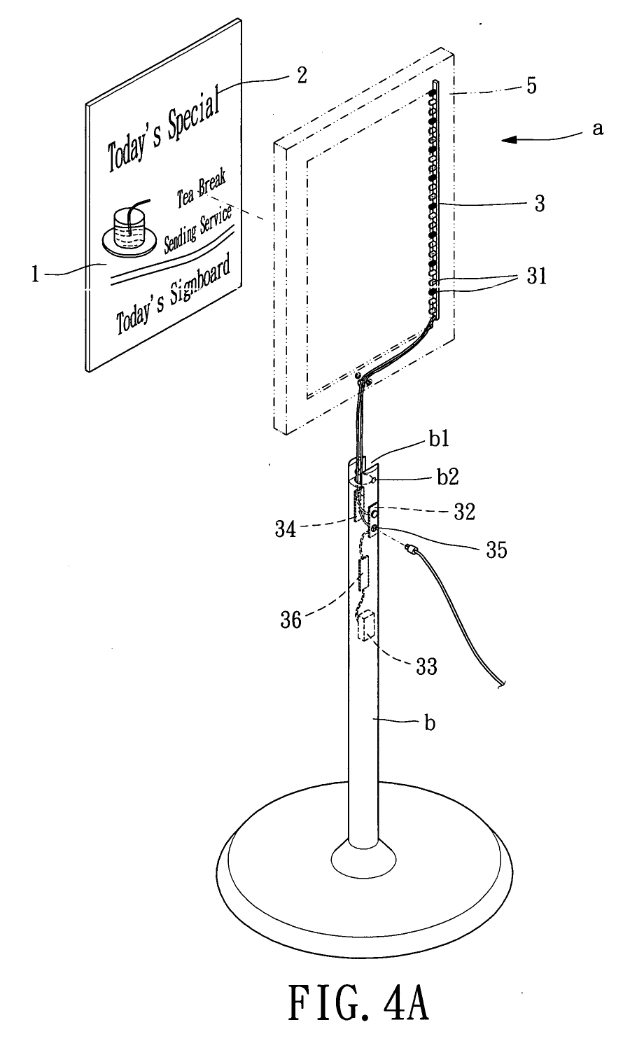

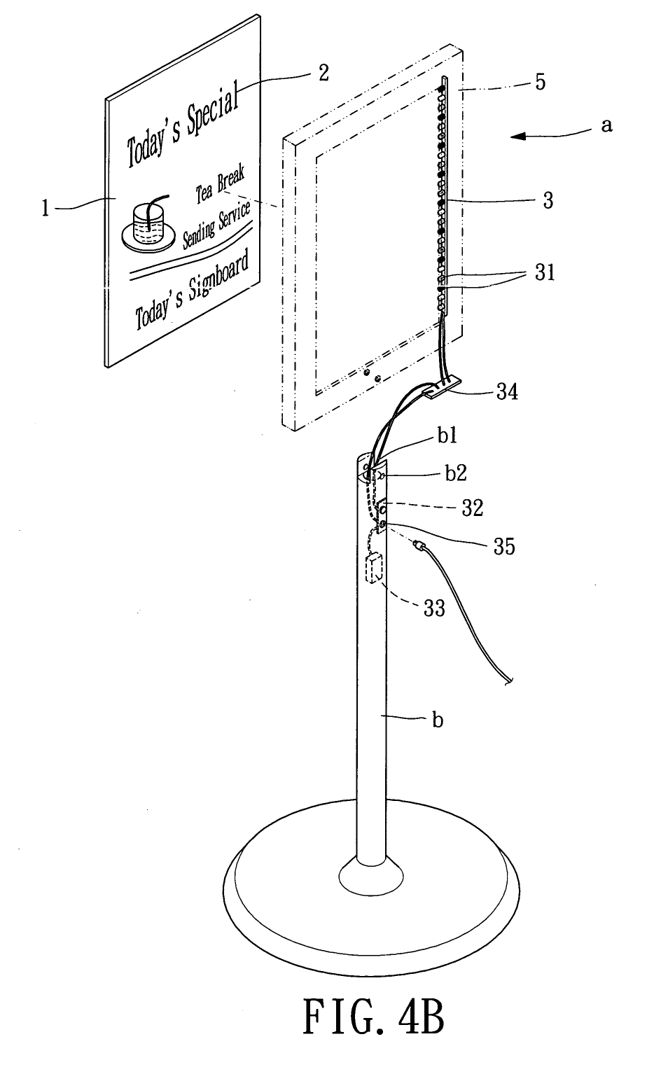

In the aforesaid embodiment, the LEDs 31 are of one single color. Alternatively, the LEDs 31 can be of different colors (see FIG. 4).

When switched on the switch 32, the LEDs 31 are turned on to give off light, and the light of the LEDs 31 passes through the transparent board 1 to the fluorescent material 2. Under the radiation of the light from the LEDs 31, the fluorescent material 2 is caused to produce light, and therefore the design of the fluorescent material 2 as well as the design 11 of the transparent board 1 are seen from a distance at night.

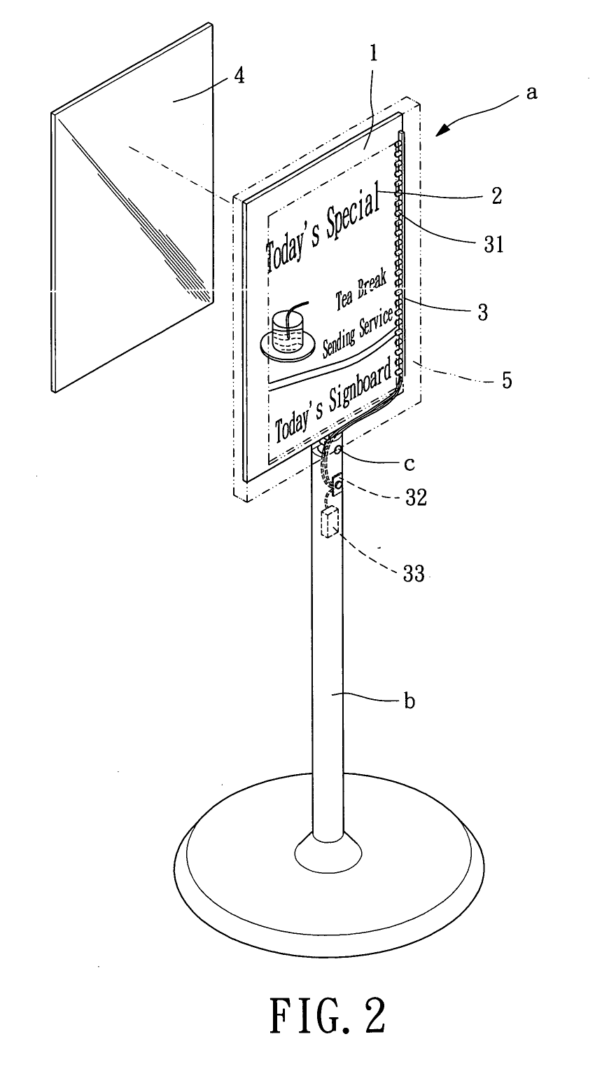

FIG. 2 shows an alternate form of the present invention. According to this embodiment, an opaque backboard 4 is fastened to the other side, namely, the back side of the frame 5 to protect the LEDs 31 and to keep the LEDs 31 from sight. The backboard 4 can be made in the form of a blackboard or whiteboard for writing or painting.

FIG. 4 shows another alternate form of the present invention. This embodiment is substantially similar to the embodiment shown in FIGS. 1˜3 with the exception of the design of the LED light source 3. According to this design, the LED light source 3 further comprises a control circuit board 34 mounted inside the stand b and electrically coupled between the switch 32 and the LEDs 31 for controlling the operation (flashing) mode of the LEDs 31, and an electric connector 35 electrically coupled to the switch 32 for receiving AC power supply through an AC adapter (not shown).

FIG. 4B shows still another alternate form of the present invention. This embodiment is substantially similar to the embodiment shown in FIG. 4 with the exception that the control circuit board 34 is mounted on the outside of the stand b.

FIG. 4A shows still another alternate form of the present invention. This embodiment is substantially similar to the embodiment shown in FIG. 4 with the exception that the battery pack 33 is a rechargeable battery, and a charging circuit board 36 is mounted inside the stand b and electrically coupled between the electric connector 35 and the battery pack 33 for charging the battery pack 33 with city power supply through an AC adapter (not shown).

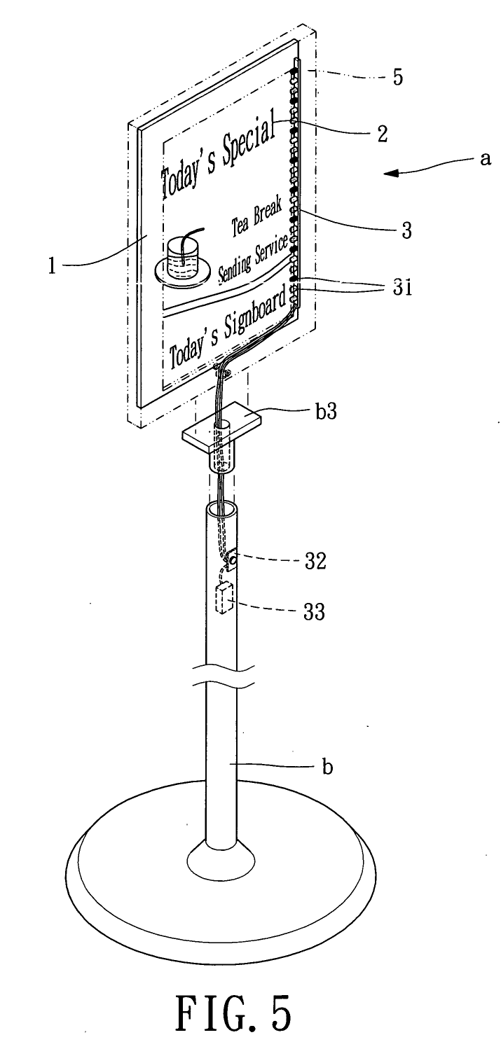

FIG. 5 shows still another alternate form of the present invention. This embodiment is substantially similar to the embodiment shown in FIG. 1 with the exception that the stand b has the top side provided with a holder member b3, and the frame 5 is affixed to the holder member b3 through a pivot joint, screw joint, or any of a variety of conventional fastening measures.

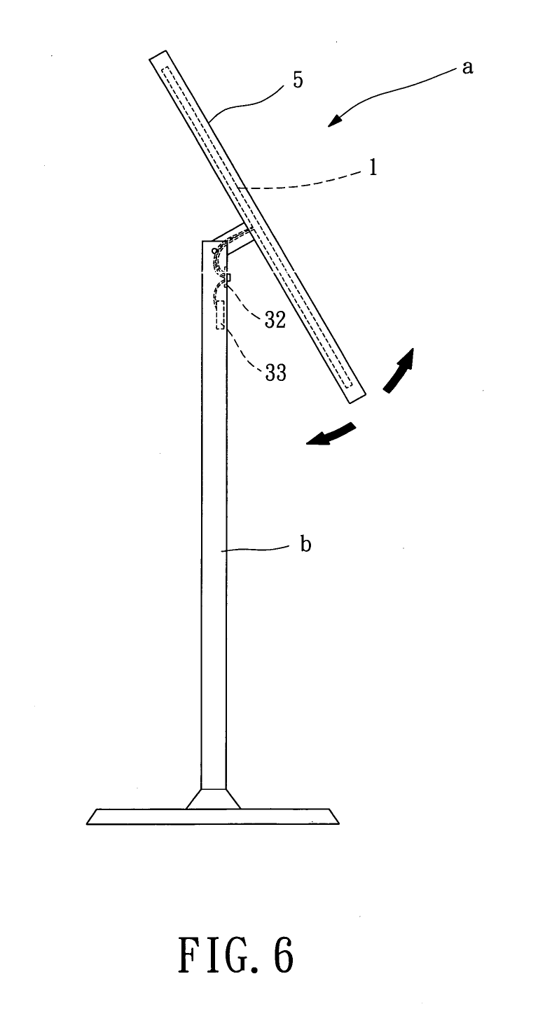

FIG. 6 shows still another alternate form of the present invention. According to this embodiment, the frame 5 of the light board assembly a pivotally mounted on the top side of the stand b, and can be turned relative to the stand b to the desired tilting angle.

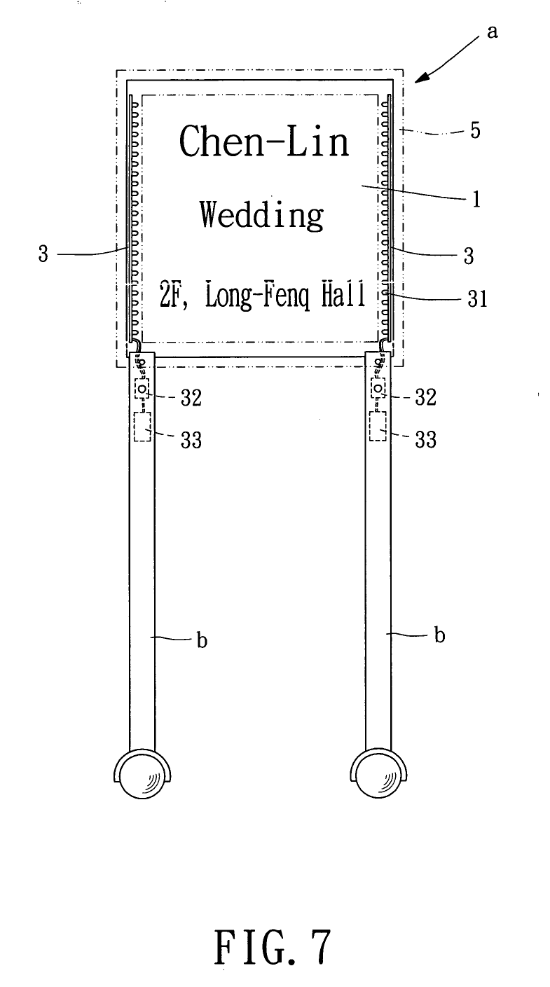

FIG. 7 shows still another alternate form of the present invention. According to this embodiment, two stands (wheeled stands) b are used to support the light board assembly a.

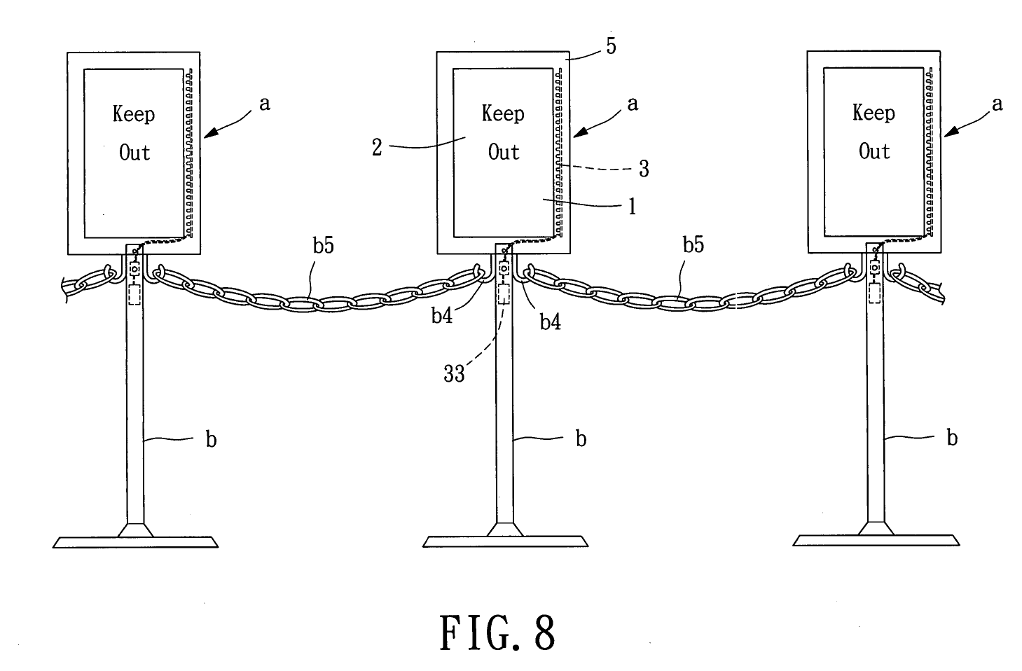

Referring to FIG. 8, a number of luminous display stands may be linked with chains b5.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A luminous display stand comprising:
a stand for positioning on the floor;
a light board assembly supported on said stand, said light board assembly comprising a board mounted, at least one light emitting diode adapted to emit light toward said board, a battery pack mounted in said stand and adapted to provide the necessary working power to said at least one light emitting diode, and an electric switch electrically coupled between said battery pack and said at least one light emitting diode for controlling the supply of electricity from said battery pack to said at least one light emitting diode; and
a fluorescent material attached to said board to show a design.

2. The luminous display stand as claimed in claim 1, wherein said stand comprises a top notch, which receives said light board assembly, a transverse mounting hole extending across said top notch, and a fastening member fastened to said transverse mounting hole to affix said light board assembly to said stand.

3. The luminous display stand as claimed in claim 1, further comprising a holder member fixedly mounted on said stand to hold said light board assembly on said stand.

4. The luminous display stand as claimed in claim 1, wherein said light board assembly further comprises a control circuit board electrically coupled between said at least one light emitting diode and said electric switch and adapted to control the operation mode of said at least one light emitting diode.

5. The luminous display stand as claimed in claim 4, wherein said control circuit board is mounted inside or outside said stand.

6. The luminous display stand as claimed in claim 1, wherein said light board assembly further comprises an electric connector mounted inside said stand and electrically coupled to said at least one light emitting diode through said electric switch for the connection of an external AC adapter.

7. The luminous display stand as claimed in claim 6, wherein said light board assembly further comprising a charging circuit board mounted inside said stand and electrically coupled to said battery pack for charging said battery pack with external power supply.

8. The luminous display stand as claimed in claim 1, wherein said board is transparent material.

9. The luminous display stand as claimed in claim 1, wherein said fluorescent material is applied to said board by handwriting.

10. The luminous display stand as claimed in claim 1, wherein said fluorescent material is applied to said board by printing.

11. The luminous display stand as claimed in claim 1, wherein said board has a back wall covered with a layer of mercury coating.

12. The luminous display stand as claimed in claim 1, wherein said board has a back wall covered with a layer of mercury film.

13. The luminous display stand as claimed in claim 1, wherein said light board assembly further comprises a frame fixedly fastened to said stand to hold said board.

14. The luminous display stand as claimed in claim 1, wherein said board has a design engraved thereon.
